(19) United States
(12) Patent Application Publication
(10) Pub. No.: US 2014/0314900 A1
(43) Pub. Date: Oct. 23, 2014

(54) MOLD ASSEMBLY FOR FABRICATING OPTICAL FIBER CONNECTOR

(71) Applicant: HON HAI PRECISION INDUSTRY CO., LTD., New Taipei (TW)

(72) Inventors: YUN-YU CHOU, New Taipei (TW); KO-HUA CHEN, New Taipei (TW)

(73) Assignee: HON HAI PRECISION INDUSTRY CO., LTD., New Taipei (TW)

(21) Appl. No.: 14/062,825

(22) Filed: Oct. 24, 2013

(30) Foreign Application Priority Data
Apr. 19, 2013 (TW) 102113882

(51) Int. Cl. B29C 45/36

(52) U.S. Cl. CPC B29C 45/36
USPC 425/577

(57) ABSTRACT

A mold assembly for fabricating an optical fiber connector includes a male mold and a first sliding block. The male mold includes a base, a first locating flange, and a second locating flange. The first locating flange and the second locating flange are spaced apart from each other. The first locating flange, the second locating flange, and the base cooperatively define a first receiving opening. A front surface of the first sliding block defines two first holes for forming two locating poles of the lens assembly. A shape and a size of the first sliding block respectively correspond to a shape and size of the first receiving opening to make the first sliding block be precisely located in the first receiving opening.

### BACKGROUND

1. Technical Field

The present disclosure relates to mold assemblies, and particularly to a mold assembly for fabricating an optical fiber connector.

2. Description of Related Art

Optical fiber connectors are widely used as interfaces for high-speed transmission of electronic data between two electronic devices. An optical fiber connector is fabricated by an injection mold. The optical fiber connector includes a male connector and a female connector coupled to the male connector. The male connector and the female connector each include a lens portion, a blind hole facing the lens portion, and an optical fiber received in the blind hole. However, it is difficult to make the lens portions align precisely with the optical fiber.

Therefore, it is desirable to provide a mold for fabricating an optical fiber connector that can overcome the above-mentioned limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an assembled, isometric view of an optical fiber connector, according to an exemplary embodiment.

FIG. 2 is an assembled, isometric view of a mold assembly in accordance with an exemplary embodiment.

FIG. 3 is an exploded, isometric view of the mold assembly of FIG. 2.

### DETAILED DESCRIPTION

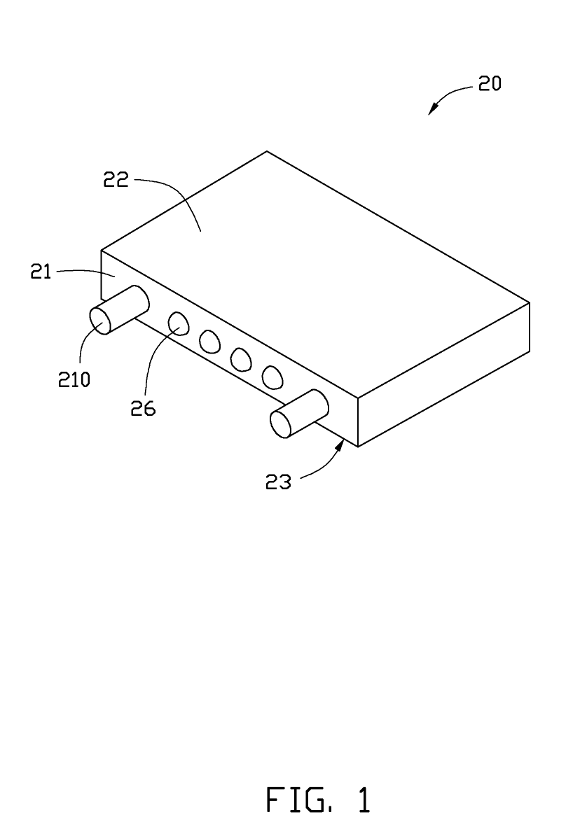

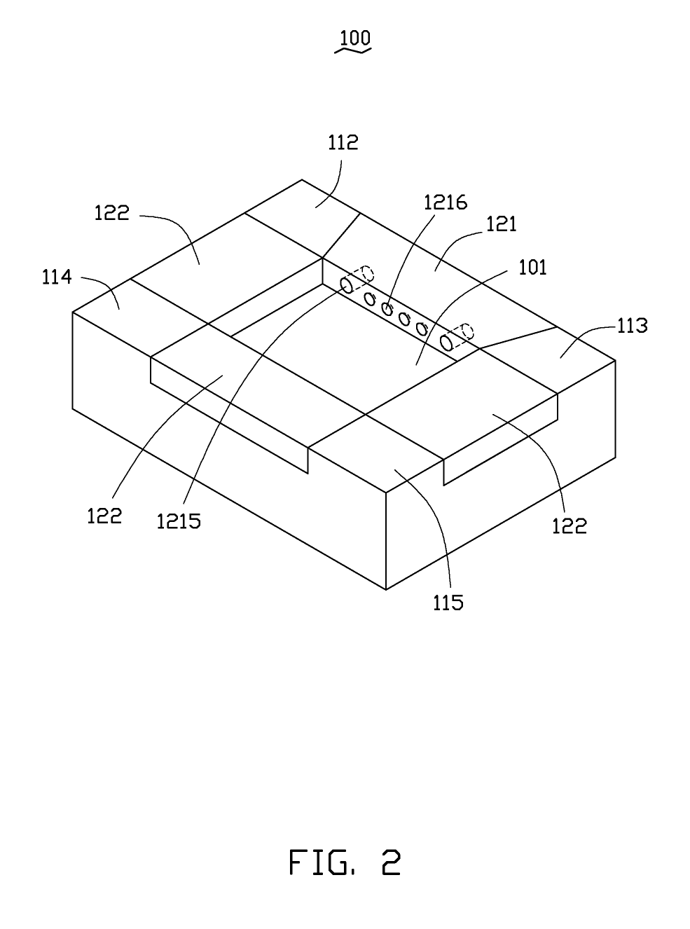

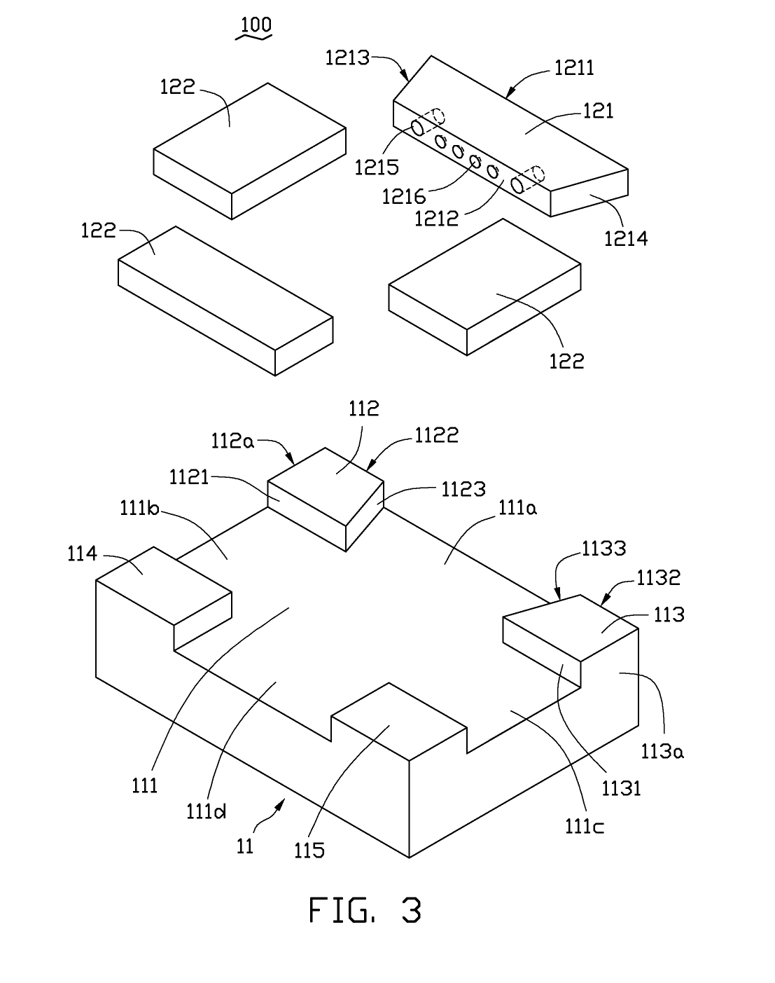

FIGS. 2-3 show a mold assembly 100 configured for fabricating an optical fiber connector 20 (as shown in FIG. 1). The optical fiber connector 20 includes a first side 21, an upper surface 22, and a lower surface 23 facing away from the upper surface 22. The upper surface 22 is substantially parallel to the lower surface 23. The first side 21 is connected substantially perpendicularly between the upper surface 22 and the lower surface 23. Two locating poles 210 extend substantially perpendicularly from the first side end 21. The first side 21 forms four light coupling lenses 26 between the two locating posts 210. In the embodiment, the light coupling lenses 26 are convex lenses and are integrally formed with the optical fiber connector 20.

The mold assembly 100 includes a male mold 11, a sliding block 121, and three second sliding blocks 122.

The male mold 11 includes a base 111, a first locating flange 112, a second locating flange 113, a third locating flange 114, and a fourth locating flange 115. The base 111 is substantially rectangular. In the embodiment, the first locating flange 112, the second locating flange 113, the third locating flange 114, and the fourth locating flange 115 are integrally formed with the base 111 and extend upward from four corners of the base 111, respectively. The first locating flange 112 is diagonal to the fourth locating flange 115. The second locating flange 113 is diagonal to the third locating flange 114.

A first receiving opening 111a is defined between the first locating flange 112 and the second locating flange 113. A second receiving opening 111b is defined between the first locating flange 112 and the third locating flange 114. A third receiving opening 111c is defined between the second locating flange 113 and the fourth locating flange 115. A fourth receiving opening 111 d is defined between the third locating flange 114 and the fourth locating flange 115.

The first locating flange 112 includes a first surface 1121 opposite to the third locating flange 114, a second surface 1122 facing away from the first surface 1121, and a first side surface 112a. The first surface 1121 is substantially parallel to the second surface 1122. The first side surface 112a is connected substantially perpendicularly between the first surface 1121 and the second surface 1122. The first locating flange 112 forms a first sloped surface 1123 extending from an edge of the first surface 1121 toward the second surface 1122. The first sloped surface 1123 faces away from the first side surface 112a. In the embodiment, a distance between the first sloped surface 1123 and the first side surface 112a gradually decreases from the first surface 1121 to the second surface 1122. A first included angle between the first surface 1121 and the first sloped surface 1123 is about 60 to about 75 degrees.

The second locating flange 113 includes a third surface 1131 opposite to the fourth locating flange 115, a fourth surface 1132 facing away from the third surface 1131, and a second side surface 113a. The third surface 1131 is substantially parallel to the fourth surface 1132. The second side surface 113a is connected substantially perpendicularly between the third surface 1131 and the fourth surface 1132. The second locating flange 113 forms a second sloped surface 1133 extending from an edge of the third surface 1131 toward the fourth surface 1132. The second sloped surface 1133 faces away from the second side surface 113a. In the embodiment, a distance between the second sloped surface 1133 and the second side surface 113a gradually decreases from the third surface 1131 to the fourth surface 1132. A second included angle between the third surface 1131 and the second sloped surface 1133 is substantially equal to the first included angle. As such, the first sloped surface 1123 and the second surface 1133 are symmetrical about the first receiving opening 111a.

The first sliding block 121 includes a back surface 1211 and a front surface 1212 facing away from the back surface 1211. The back surface 1211 is substantially parallel to the front surface 1212. A shape and a size of the first sliding block 121 correspond to a shape and a size of the first receiving opening 111a. The first sliding block 121 forms a third sloped surface 1213 and a fourth sloped surface 1214 matching the first sloped surface 1123 and the second sloped surface 1133, respectively. Both the third sloped surface 1213 and the fourth sloped surface 1214 extend from the back surface 1211 toward the front surface 1212. The third sloped surface 1213 faces away from the fourth sloped surface 1214.

The front surface 1212 defines two first holes 1215 for forming the two locating poles 210 and four second holes 1216 for forming the four light coupling lenses 26. The four second holes 1216 are defined between the two first holes 1215.

The second receiving opening 111b, the third receiving opening 111c, and the fourth receiving opening 111d have substantially a same shape. A shape and a size of the second receiving opening 111b respectively correspond to a shape and size of the second sliding block 122.

In assembly, the first sliding block 121 is slidably received in the first receiving opening 111a. The three second sliding blocks 122 are slidably received in the second receiving opening 111b, the third receiving opening 111c, and the fourth receiving opening 111d, correspondingly. The first sliding block 121, the second sliding blocks 122, and the male mold 11 cooperatively define a die cavity 101. The first sliding block 121 is precisely located in the first receiving opening 111a to ensure that the two locating posts 210 and the four light coupling lenses 26 are formed in the correct location.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A mold assembly for fabricating an optical fiber connector, the mold assembly comprising:
a male mold comprising a base, a first locating flange, and a second locating flange, both the first locating flange and the second locating flange extending upward from the base, the first locating flange and the second locating flange spaced apart from each other, the first locating flange comprising a first sloped surface, the second locating flange comprising a second sloped surface opposite to the first sloped surface, the male mold defining a first receiving opening between the first locating flange and the second locating flange; and
a first sliding block defining two first holes for forming two locating poles of the optical fiber connector, the first sliding block comprising a third sloped surface spatially corresponding to the first sloped surface and a fourth surface spatially corresponding to the second sloped surface, wherein a shape and a size of the first sliding block respectively correspond to a shape and a size of the first receiving opening to make the first sliding block be precisely located in the first receiving opening.

2. The mold assembly of claim 1, wherein the first sliding block comprises a back surface and a front surface facing away from the top surface, the two first holes are defined in the back surface.

3. The mold assembly of claim 1, wherein the back surface defines four second holes configured for forming four light coupling lenses of the optical fiber connector.

4. The mold assembly of claim 1, wherein the base is substantially rectangular, the first locating flange and the second locating flange are respectively located on two corners of the base.

5. The mold assembly of claim 1, wherein the base comprises a third locating flange and a fourth locating flange, the third locating flange and the fourth locating flange are respectively located on another two corners of the base.

6. The mold assembly of claim 5, comprising three second sliding blocks, wherein the male mold defines a second receiving opening between the first locating flange and the third locating flange, a third receiving opening between the second locating flange and the fourth locating flange, and a fourth receiving opening between the third locating flange and the fourth locating flange, the three second sliding blocks are respectively slidably received in the second receiving opening, the third receiving opening, and the fourth receiving opening.

7. The mold assembly of claim 6, wherein the first sliding block, the second sliding blocks, and the male mold cooperatively define a die cavity.

8. The mold assembly of claim 5, wherein the first locating flange, the second locating flange, the third locating flange, and the fourth locating flange are integrally formed with the base.

9. The mold assembly of claim 1, wherein the first locating flange comprises a first surface opposite to the third locating flange, a second surface facing away from the first surface, and a first side surface, the first surface is substantially parallel to the second surface, the first side surface is connected substantially perpendicularly between the first surface and the second surface, the first sloped surface extends from the first surface toward the second surface, the first sloped surface faces away from the first side surface.

10. The mold assembly of claim 9, wherein a distance between the first sloped surface and the first side surface gradually decreases from the first surface to the second surface.

11. The mold assembly of claim 9, wherein a first included angle between the first surface and the first sloped surface is about 60 to about 75 degrees.

12. The mold assembly of claim 11, wherein the second locating flange comprises a third surface, a fourth surface facing away from the third surface, and a second side surface, the third surface is substantially parallel to the fourth surface, the second side surface is connected substantially perpendicularly between the third surface and the fourth surface, the second sloped surface extends from the third surface toward the fourth surface, the second sloped surface faces away from the second side surface.

13. The mold assembly of claim 12, wherein a distance between the second sloped surface and the second side surface gradually decreases from the third surface to the fourth surface.

14. The mold assembly of claim 12, wherein a second included angle between the third surface and the second sloped surface is substantially equal to the first included angle.

15. The mold assembly of claim 1, wherein the first sloped surface and the second sloped surface are symmetrical about the first receiving opening.
